(19) United States
(12) Patent Application Publication
(10) Pub. No.: US 2017/0163935 A1
(43) Pub. Date: Jun. 8, 2017

(54) VIDEO CONFERENCE SYSTEM AND METHOD THEREOF

(71) Applicant: AVer Information Inc., New Taipei City (TW)

(72) Inventor: Chen-hsun CHAI, New Taipei City (TW)

(21) Appl. No.: 15/067,782

(22) Filed: Mar. 11, 2016

(30) Foreign Application Priority Data
Dec. 2, 2015 (TW) 104140399

(51) Int. Cl. H04N 7/15

(52) U.S. Cl. CPC H04N 7/15

(57) ABSTRACT

A video conference system includes an indicator and a video conference server device. The video conference server device communicates to the indicator. The indicator includes a triggering module. When the triggering module is triggered, the indicator outputs a piece of displacement information which is corresponding to the indicator. The video conference server device produces an output image according to the piece of displacement information, an initial position and a slide image. The video conference transfers the output image to at least one video conference client terminal.

### CROSS REFERENCE

The present application is based on, and claims priority from, Taiwan Application Serial Number 104140399, filed on Dec. 2, 2015, the disclosure of which is hereby incorporated by reference herein in its entirety.

### TECHNICAL FIELD

This disclosure is related to a video conference system and method thereof, and particularly to a video conference system and method equipping with a slide indicator

### BACKGROUND

As the progress of the communication technique, the communication between people is not limited by space. Two persons may communicate with each other with a variety of communication techniques and/or apparatus even if they are apart from each other. In old days, the attendees of a conference have to hold the conference together face to face because of the bottleneck of communication. Nowadays, the voices and the images of the attendees, the audience and the speaker, can be converted to a stream of data and transferred to other attendees. A variety of communication techniques improve the flexibility of holding a conference.

Although the audience is capable of attending the conference with the technique of video conference disregarding the limitation of the difference in space, there is certain inconvenience in the technique of video conference. For example, the audience can watching the body language of the speaker via the video but cannot catch what is emphasized by the speaker intuitively when the speaker wants to emphasize certain content in his presentation. In another condition, the speaker has to emphasize certain content of his presentation by the assistance of particular software and cannot directly point out what he what to emphasize with body language.

### SUMMARY

A method and a video conference system are provided in this disclosure. The video conference system according to one embodiment of this disclosure includes an indicator and a video conference server. The video conference server communicates with the indicator. The indicator has a triggering module. When the triggering module is triggered, the indicator outputs the piece of displacement information corresponding to the indicator. The video conference server generates an output image based on the piece of displacement information, an initial position, and a slide image and transfers the output image to at least one video conference client terminal.

In order to make the aforementioned and other features of the present disclosure more comprehensible, several embodiments accompanied with figures are described in detail below.

### BRIEF DESCRIPTION OF THE DRAWINGS

The present disclosure will become more fully understood from the detailed description given herein below for illustration only, and thus are not limitative of the present disclosure, and wherein:

FIG. 1 is the functional block diagram of the video conference system according to one embodiment of this disclosure;

FIG. 2 illustrates the operations of the video conference system according to another embodiment of this disclosure;

FIG. 3 illustrates the operations of the video conference system according to yet another embodiment of this disclosure; and

FIG. 4 is a flowchart of the method for video conference according to one embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

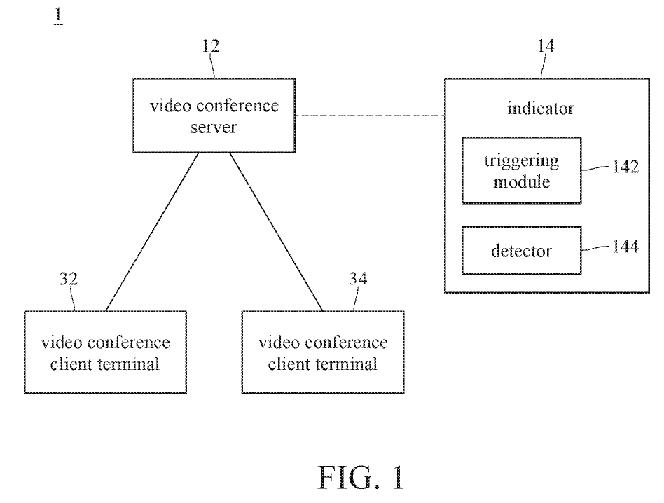

Please refer to FIG. 1, which is the functional block diagram of the video conference system according to one embodiment of this disclosure. The video conference system 1 in this embodiment includes a video conference server 12, an indicator 14, and two video conference client terminals 32 and 34. The video conference server 12 communicates with the indicator 14, the video conference client terminal 32, and the video conference client terminal 34, respectively. The indicator 14 has a triggering module 142 therein. In one embodiment, the video conference server 12, the video conference client terminal 32 and the video conference client terminal 34 may be products of different manufacturers. Although the embodiments below illustrate only two video conference client terminals, the number of the video conference client terminals in the video conference system is not limited by the embodiments below.

When the triggering module 142 is triggered, the indicator 14 outputs the piece of displacement information corresponding to the indicator 14. In one embodiment, the indicator 14 further has the detector 144. The detector 144 is capable of detecting the displacement direction of the indicator 14 and the displacement value of the indicator 14 so as to generate the piece of displacement information. The detector 144 is, for example but not limited to, a gravity sensor (G-sensor) or an electronic compass. Specifically, the detector 144 is selectively enabled based on whether the triggering module 142 is triggered. In one embodiment, the detector 144 is originally disabled or deactivated. When the triggering module 142 is triggered, the detector 144 is enabled or activated to detect the displacement direction of the indicator 14 and the displacement value of the indicator 14 so as to generate the piece of displacement information. In another embodiment, the detector 144 continuously detects the displacement direction of the indicator 14 and the displacement value of the indicator 14 to generate the piece of displacement information no matter the triggering module 142 is triggered or not. In this embodiment, when the triggering module 142 is triggered, the indicator 14 outputs the piece of displacement information to the video conference server 12. The indicator 14 is, for example but not limited to, application specified presenter, a smart phone executing a specified application program, or a tablet executing a specified application program.

The video conference server 12 receives the slide images such as the images from the speaker's computer. The slide images may include the slideshow files such as power point files in the speaker's computer. The video conference server 12 generates the output image based on the received slide image and transfers the output image to the video conference client terminal 32 and/or the video conference client terminal 34 so that the audiences in other place may be aware of the content of the slides of the speaker via the video conference client terminal 32 and/or the video conference client terminal 34. The output image is generated from the slide image with or without image processing. The video conference server 12, for example, receives the slide image from the computer via the video graphics array (VGA) and transfers the output image to the video conference client terminal 32 or 34 with the H.239 protocol, the H.246 protocol, or other adequate protocols.

In one embodiment, when the video conference server 12 receives the piece of displacement information from the indicator 14, the video conference server 12 generates the output image based on the piece of displacement information, the initial position, and the slide image. Explicitly, the piece of displacement information includes the displacement direction and the displacement value. In one embodiment, the initial position is a reference point in the slide image, such as the central point or one of the corner points. In other embodiment, the initial position is defined based certain auxiliary lines on the slide image. The video conference server 12 determines a relative position on the slide image based on the initial position, the displacement direction, and the displacement value. The video conference server 12 embeds an indicating icon at the relative position on the slide image.

Therefore, the output image is generated and includes the slide image and the indicating icon on the slide image. In other words, every time the video conference server 12 receives a new piece of displacement information, the video conference server 12 updates the position of the indicating icon so that the indicating icon moves as the indicator 14 moved by the speaker.

In some embodiments, the video conference server 12 communicates with the indicator 14 and/or the video conference client terminal 32 and the video conference client terminal 34 with wireless communication techniques such as Bluetooth (BT), wireless fidelity (WI-FI), 2^{nd} generation, 3^{rd} generation or 4^{th} generation communication techniques, or via universal serial bus (USB), high definition multimedia interface (HDMI) or other lined-communication techniques.

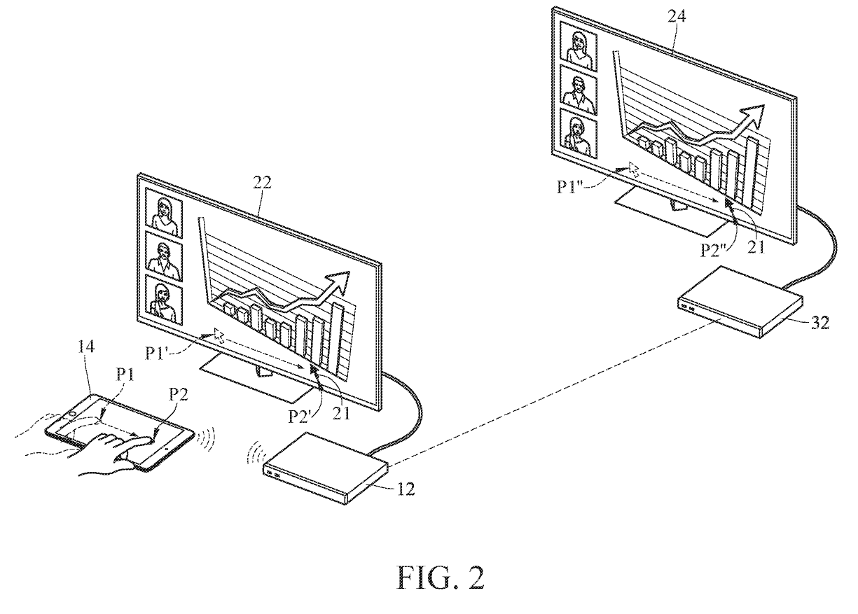

Please refer to FIG. 2 for further description of the operations of the video conference system, wherein FIG. 2 illustrates the operations of the video conference system according to another embodiment of this disclosure. As shown in FIG. 2, in one embodiment, the video conference server 12 is further electrically connected to the display device 22 to display the output image with the display device 22, and the video conference client terminal 32 is electrically connected to the display device 24 to display the output image with the display device 24. In another embodiment, the video conference server 12 and/or the video conference client terminal 32 includes a display module therein to display the output image, and the display device 22 or 24 is not necessary. In this embodiment, the indicator 14 is, for example, a tablet computer executing a specified application program. The triggering module 142 and the detector 144 are, for example, integrated as the touch panel or the touch display of the table computer. The speaker, for example, touches the touch panel to control the movement of the indicating icon 21.

Specifically, the speaker touches the position P1 on the indicator 14 with his finger firstly, and moves his finger with touching the triggering module 142 from the position P1 to the position P2. Correspondingly, the indicator 14 detects the difference in position of the speaker's finger by the detector 144, the touch panel, when the speaker moves his finger on the touch panel of the indicator 14, the tablet computer. The indicator refreshes the piece of the displacement information accordingly. The video conference server 12 moves the indicating icon 21 of the output image based on the continuously refreshed piece of displacement information. The speaker and the audience are capable of watching the indicating icon 21 moving on the output image via the display device 22 and the display device 24, respectively. Explicitly, the speaker would find out in the display device 22 that the indicating icon 21 moves from the position P1′ to the position P2′, and the audience would find out in the display device 24 that the indicating icon 21 moves from the position P1″ to the position P2″. That is, the speaker makes the video conference server 12 to generate the output image including the indicating icon 21 by moving the indicator 14, and the position of the indicating icon 21 moves according to the movement made by the speaker. Therefore, the output image is capable of assisting the speaker in presentation.

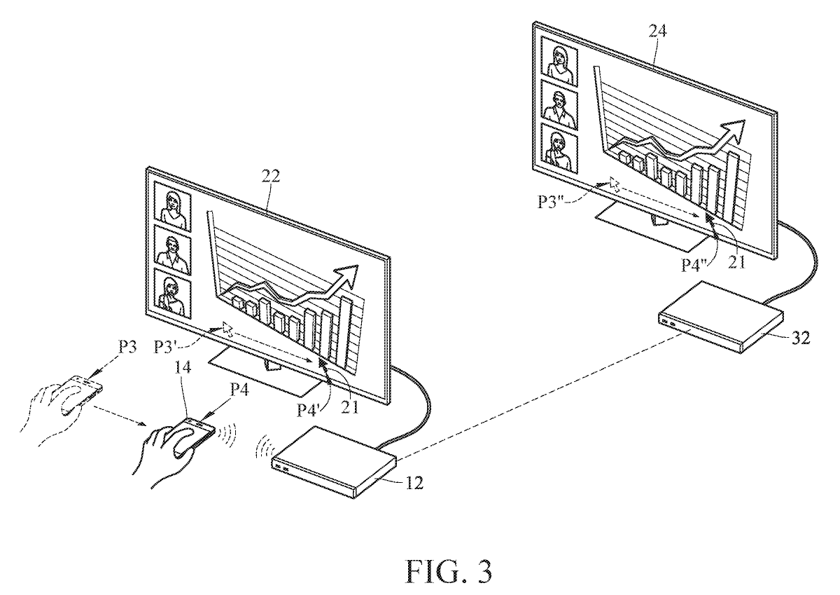

In yet another embodiment, please refer to FIG. 3, which illustrates the operations of the video conference system according to yet another embodiment of this disclosure. As shown in FIG. 3, the indicator 14 is a smart phone executing a specified application program. In this embodiment, the speaker holds the indicator 14 and moves the indicator 14 from the position P3 to the position P4. The indicator 14 detects the variation of the position of the indicator 14 and continuously refreshes the piece of displacement information accordingly. The video conference server 12 moves the indicating icon 21 continuously based on the refreshed piece of displacement information. Similarly, the speaker and the audience are capable of watching the indicating icon 21 moving on the output image via the display device 22 and the display device 24, respectively. Explicitly, the speaker would find out in the display device 22 that the indicating icon 21 moves from the position P3′ to the position P4′, and the audience would find out in the display device 24 that the indicating icon 21 moves from the position P3″ to the position P4″. That is, the speaker makes the video conference server 12 to generate the output image including the indicating icon 21 by moving the indicator 14, and the position of the indicating icon 21 moves according to the movement made by the speaker. Therefore, the output image is capable of assisting the speaker in presentation, and the speaker is capable of emphasizing certain content of the presentation by the body language intuitively.

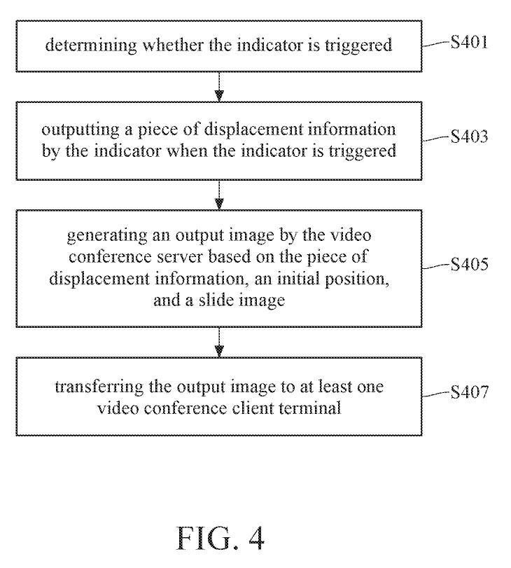

Briefly, the embodiments above illustrate the method for video conference provided in this disclosure. Please refer to FIG. 4 for the disclosed method, wherein FIG. 4 is a flowchart of the method for video conference according to one embodiment of this disclosure. The method for video conference is applicable for the video conference system including at least a video conference server and an indicator. The method includes the steps of: In step S401, whether the indicator is triggered is determined first. When the indicator is triggered, as shown in step S403, the indicator is controlled to output a piece of displacement information. In step S405, the video conference server generates an output image based on the piece of displacement information, an initial position, and a slide image. Then, in step S407, the output image is transferred to at least one video conference client terminal.

As above, a video conference system and a method thereof is provided in this disclosure. By detecting a piece of displacement information corresponding to the indicator, the movement of the hand of the speaker is sensed. The piece of displacement information is, for example, the movement of the speaker's finger, the movement of the indicator controlled by the speaker, or other difference in position corresponding to the indicator and controlled by the speaker. The video conference system and the method thereof determine a relative position based on the piece of displacement information and the initial point on the slide image. An indicating icon is embedded at the relative position on the slide image. Hence, the indicating icon moves corresponding to the movement of the hand of the speaker, and the movement of the speaker is in connection with the content of the slide. Then speaker may provide intuitive content of speech with said system.

1. A video conference system, comprising:
an indicator having a triggering module therein, when the triggering module is triggered, the indicator outputs a piece of displacement information corresponding to the indicator; and
a video conference server communicating with the indicator, the video conference server generating an output image based on the piece of displacement information, an initial position, and a slide image, and transferring the output image to at least one video conference client;
wherein the indicator further comprises a detector capable of detecting a displacement direction and a displacement value so as to generate the piece of displacement information.

2. (canceled)

3. The video conference system of claim 1, wherein the displacement value and the displacement direction are both corresponding to the indicator.

4. The video conference system of claim 1, wherein the detector is enabled to detect the displacement direction and the displacement value corresponding to the indicator to generate the piece of displacement information when the triggering module is triggered.

5. The video conference system of claim 1, wherein the detector outputs the piece of displacement information to the video conference server when the triggering module is triggered.

6. The video conference system of claim 1, wherein the video conference server determines a relative position in the slide image based on the piece of displacement information and the initial position, and embeds an indicating icon at the relative position of the slide image so as to generate the output image.

7. A method for video conference, applicable for a video conference system, the video conference system having a video conference server and a indicator, the method comprising:
determining whether the indicator is triggered;
outputting a piece of displacement information by the indicator when the indicator is triggered;
generating an output image by the video conference server based on the piece of displacement information, an initial position, and a slide image; and
transferring the output image to at least one video conference client terminal;
wherein the indicator further comprises a detector, and the method further comprises:
detecting a displacement direction;
detecting a displacement value; and
generating the piece of the displacement information based on the displacement direction and the displacement value.

8. (canceled)

9. The method of claim 7, wherein the displacement value and the displacement direction are both corresponding to the indicator.

10. The method of claim 7, wherein the detector is enabled to detect the displacement direction and the displacement value to generate the piece of displacement information when the indicator is triggered.

11. The method of claim 7, wherein the step of generating an output image by the video conference server based on the piece of displacement information, an initial position, and a slide image comprises:
determining a relative position in the slide image based on the piece of displacement information and the initial position; and
embedding an indicating icon at the relative position of the slide image so as to generate the output image.
